(19) United States
(12) Patent Application Publication
(10) Pub. No.: US 2026/0192588 A1
(43) Pub. Date: Jul. 9, 2026

(54) Interactive Book with Concealed Photograph Display

(71) Applicant: Maribel Angulo, San Diego, CA (US)

(72) Inventor: Maribel Angulo, San Diego, CA (US)

(21) Appl. No.: 19/011,638

(22) Filed: Jan. 7, 2025

(51) Int. Cl. B42D 1/08; B42D 1/00; B42D 3/12

(52) U.S. Cl. CPC B42D 1/08; B42D 1/006; B42D 3/12; B42P 2201/02

(57) ABSTRACT

A book comprising three sections, with the first and third sections foldably connected to opposing edges of the second section, forming respective pages. The second section includes a photograph display area configured to present a photograph. The first and third sections are foldable relative to the second section, enabling the photograph to be concealed when the third section is folded inward over the second section and revealed when unfolded. The photograph display area supports various methods of photograph integration, including photo-receiving pockets, permanent printing, or affixing by adhesive or other means.

### FIELD OF INVENTION.

The present invention relates to books with integrated structures for displaying photographs, specifically those configured to conceal and reveal photographs as part of an interactive book format.

### BACKGROUND

In the field of children's books and early education tools, numerous efforts have been made to enhance engagement and learning experiences for young children, particularly those in the formative years of early cognitive and emotional development. Traditional children's books often rely solely on illustrations and written narratives to captivate their audience, providing limited interactivity or personalization. While these books may succeed in fostering basic literacy and imagination, they often fail to incorporate elements that actively stimulate a child's curiosity and sense of connection with familiar individuals or environments. Furthermore, such books typically lack features that allow parents or caregivers to integrate personalized content, such as photographs, into the storytelling process, which could otherwise deepen the emotional and educational impact of the reading experience.

Efforts to bridge this gap have resulted in innovations such as photo albums and hybrid products combining educational tools with imagery. Photo albums, while suitable for displaying personal photographs, are primarily designed for archival purposes and are ill-suited for interactive use by young children. The materials used in these albums, such as thin plastic sheets or adhesive backings, are prone to damage from rough handling, drooling, or tearing by infants and toddlers. Moreover, photo albums are typically cumbersome and lack any narrative or storytelling elements that would engage children during use. As a result, they do not function effectively as tools for early childhood development or interactive play.

On the other hand, board books and other rigid, child-friendly books have emerged as a popular solution for creating durable reading materials for young children. While these books are designed to withstand rough handling and provide engaging content, their scope is generally limited to static illustrations and printed text. Even board books that incorporate interactive elements, such as flaps or textures, primarily focus on sensory engagement without offering personalization or integration of personal photographs. Existing attempts to combine photo albums with children's books, such as books with adhesive-backed photo pockets or printed photo illustrations, often result in products that are either too fragile for practical use by children or lack the interactive and surprise elements that are crucial for maintaining a child's attention.

Despite the availability of customizable books and interactive children's products, there remains a lack of solutions that combine the durability of board books, the personal relevance of photo albums, and the interactive features necessary to engage young readers. Existing systems often fail to incorporate mechanisms that allow for both secure placement of photographs and the element of discovery, which is particularly effective in stimulating early cognitive development. Furthermore, these products rarely align with the storytelling and emotional connection that parents and caregivers seek to foster during shared reading experiences. This void in the market highlights the need for an innovative approach that integrates personalization, durability, and interactive storytelling into a unified solution for young children.

It is within this context that the present invention is provided.

### SUMMARY

The present invention relates to a book comprising a first section, a second section, and a third section, wherein the first and third sections are foldably connected to opposing edges of the second section. The surfaces of these sections form respective pages of the book. The second section includes a photograph display area configured to present a photograph. The first and third sections are foldable relative to the second section, such that when the third section is folded inward over the second section, the photograph is concealed. This configuration enables an interactive user experience where photographs can be revealed or concealed as part of the book's structure.

The invention provides a flexible system for incorporating photographs into a book format, allowing photographs to be displayed, concealed, or revealed in a manner that enhances engagement and functionality. It is applicable to a wide range of material constructions and methods for securing or displaying photographs, making it adaptable to various manufacturing processes and user preferences.

In some embodiments, the photograph display area comprises a photo-receiving pocket integrated into the second section, configured to receive and retain a photograph or a photograph holder. This facilitates easy insertion and removal of photographs without damaging the book structure.

In further embodiments, the photo-receiving pocket includes a top access opening to guide the insertion and removal of photographs or photograph holders. This configuration provides convenience for users while ensuring photographs remain securely in place

In yet further embodiments, the photograph display area comprises a photograph permanently printed onto the inner surface of the second section. This simplifies the manufacturing process and eliminates the need for additional components, such as pockets or holders, while maintaining the interactive conceal-and-reveal functionality.

In some embodiments, the photograph display area comprises a photograph affixed to the inner surface of the second section using an adhesive, fastener, or other securing means. This offers a versatile method of incorporating photographs into the book, allowing for temporary or permanent attachment depending on user needs.

In further embodiments, the first, second, and third sections are constructed from board material, enhancing durability and making the book suitable for rough handling, particularly by young children.

In yet further embodiments, the sections are constructed from fabric material, offering a softer, more tactile option for users seeking an alternative to rigid book materials.

In some embodiments, the first and third sections include flaps with shapes and designs integrated into different story themes. This enhances the visual and narrative appeal of the book, making it engaging for users.

In further embodiments, the photo-receiving pocket is configured to accommodate photographs of multiple standard sizes. This ensures compatibility with widely available photograph formats, providing flexibility for users.

In yet further embodiments, the photo-receiving pocket includes alignment tabs or guides to assist with accurate placement of the photograph or holder. This improves ease of use and ensures that photographs are consistently positioned for optimal visibility through the opening.

In some embodiments, the invention includes multiple photo-receiving pockets integrated into the second section, allowing for the display of several photographs in a single spread. This increases the book's capacity for personalization and functionality.

In further embodiments, the first and third sections include decorative cutouts or transparent windows to partially reveal portions of the photograph when the book is folded. This provides a partial view of the photograph, enhancing the interactive experience.

In yet further embodiments, the book integrates with digital or electronic components, enabling photographs to be displayed electronically. This expands the functionality of the book, making it adaptable to modern technological applications.

In some embodiments, the book is configured to integrate with photo printing services, allowing users to order customized photographs pre-fitted to the dimensions of the photograph display area. This streamlines the customization process for users.

In further embodiments, the opening in the second section is formed as part of a story-relevant design. This enhances the narrative and thematic integration of the photographs with the book's content.

In yet further embodiments, the photo-receiving pocket is formed by laminating or bonding a transparent sheet to the inner surface of the second section. This provides additional protection for photographs while maintaining their visibility through the opening.

In some embodiments, the first and third sections are secured in their folded position using magnets, hook-and-loop fasteners, or other releasable securing elements. This ensures that the sections remain closed when desired, adding to the book's functionality.

In further embodiments, the photograph display area includes a customizable overlay to enhance or modify the appearance of the photograph. This provides users with additional creative control over the presentation of their photographs.

In yet further embodiments, the book includes additional sections, each with a photograph display area, enabling the concealment and revelation of multiple photographs across different pages. This increases the overall capacity of the book for interactive and personalized storytelling.

### BRIEF DESCRIPTION OF THE DRAWINGS

Various embodiments of the invention are disclosed in the following detailed description and accompanying drawings.

FIG. 1 illustrates an example of the book in an open configuration with a partially inserted photograph holder visible through the opening in the second section.

FIG. 2 illustrates an example of the book in an open configuration with the photograph holder fully inserted into the photo-receiving pocket and aligned with the opening.

FIG. 3 illustrates an example of the book in a partially closed configuration with the third section folded inward to conceal the photograph display area.

FIG. 4 illustrates an example of the book in an open configuration where the photograph is permanently printed onto the inner surface of the second section and visible through the opening.

Common reference numerals are used throughout the figures and the detailed description to indicate like elements. One skilled in the art will readily recognize that the above figures are examples and that other architectures, modes of operation, orders of operation, and elements/functions can be provided and implemented without departing from the characteristics and features of the invention, as set forth in the claims.

### DETAILED DESCRIPTION AND PREFERRED EMBODIMENT

The following is a detailed description of exemplary embodiments to illustrate the principles of the invention. The embodiments are provided to illustrate aspects of the invention, but the invention is not limited to any embodiment. The scope of the invention encompasses numerous alternatives, modifications and equivalent; it is limited only by the claims.

Numerous specific details are set forth in the following description in order to provide a thorough understanding of the invention. However, the invention may be practiced according to the claims without some or all of these specific details. For the purpose of clarity, technical material that is known in the technical fields related to the invention has not been described in detail so that the invention is not unnecessarily obscured.

### Definitions

The terminology used herein is for the purpose of describing particular embodiments only and is not intended to be limiting of the invention.

As used herein, the term “and/or” includes any combinations of one or more of the associated listed items.

As used herein, the singular forms “a,” “an,” and “the” are intended to include the plural forms as well as the singular forms, unless the context clearly indicates otherwise.

It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

When a feature or element is described as being “on” or “directly on” another feature or element, there may or may not be intervening features or elements present. Similarly, when a feature or element is described as being “connected,” “attached,” or “coupled” to another feature or element, there may or may not be intervening features or elements present. The features and elements described with respect to one embodiment can be applied to other embodiments.

The use of spatial terms, such as “under,” “below,” “lower,” “over,” “upper,” etc., is used for ease of explanation to describe the relationship between elements when the apparatus is in its proper orientation.

The terms “first,” “second,” and the like are used to distinguish different elements or features, but these elements or features should not be limited by these terms. A first element or feature described can be referred to as a second element or feature and vice versa without departing from the teachings of the present disclosure.

The term “section” refers to any component of the book that forms a distinct part of the overall structure, with surfaces that can function as pages when the book is opened. This includes, but is not limited to, rigid panels made of board material, flexible layers such as fabric or plastic sheets, or laminated constructions. In one example implementation, the sections may be made of laminated cardboard with a thickness of approximately 1.5 millimeters, providing durability and rigidity suitable for children's use. Alternatively, the sections may be formed from soft textile materials, such as cotton fabric reinforced with foam, offering a tactile and lightweight option.

The term “photograph display area” refers to any region or mechanism within the book configured to present a photograph. This includes, but is not limited to, photo-receiving pockets, adhesive areas, or printed regions. In one example implementation, the photograph display area may comprise a transparent plastic pocket bonded to the inner surface of the second section, with an access opening along the top edge. In another example, the photograph may be printed directly onto the surface of the second section using dye sublimation printing.

The term “photo-receiving pocket” refers to a structure configured to securely hold a photograph or a photograph holder within the second section. This includes, but is not limited to, enclosures formed by laminating transparent plastic over a backing surface, stitched fabric sleeves, or molded plastic compartments. In one example implementation, the pocket may be a rectangular transparent sleeve made of polyethylene film, heat-sealed to the inner surface of the second section with an opening sized to fit standard 4×6-inch photographs.

The term “opening” refers to any aperture, window, or cutout formed in the inner surface of the second section that allows a photograph or portion thereof to be visible. This includes, but is not limited to, rectangular, circular, or custom-shaped cutouts. In one example implementation, the opening may be die-cut into a cardboard panel, surrounded by a printed decorative frame. Alternatively, the opening may include a transparent overlay to protect the photograph while maintaining visibility.

The term “foldable connection” refers to any structure or mechanism that enables one section of the book to rotate or bend relative to another section. This includes, but is not limited to, hinge-like connections formed by scoring or creasing a rigid material, flexible fabric or plastic hinges, or mechanical fasteners. In one example implementation, the foldable connection may be a score line in a laminated cardboard structure. Alternatively, it may be a stitched hinge formed by sewing two fabric sections together along their edges.

The materials used in constructing the book may vary depending on the desired application. In one example, the sections may be constructed from recycled cardboard for environmental sustainability. Alternatively, high-density polyethylene sheets may be used for enhanced durability in outdoor environments. The adhesive for bonding transparent pockets to the section may include water-based acrylic adhesives, while solvent-based adhesives could be employed for fabric constructions. Printing on the book may utilize UV-cured ink for durability or water-based ink for eco-friendliness. These implementations ensure flexibility in adapting the book design to specific manufacturing requirements and user preferences.

### DESCRIPTION OF DRAWINGS

The present invention relates to a book with an interactive structure designed to present, conceal, and reveal photographs as part of its integrated design. This book addresses significant shortcomings of prior art systems, which either lack interactivity, durability, or the ability to personalize the content seamlessly. Traditional photo albums are often unsuitable for young children due to their fragile materials and lack of narrative integration, while children's books typically do not provide mechanisms for incorporating personal photographs in a secure and engaging manner. Additionally, existing customizable books often fail to incorporate elements of surprise or concealment that enhance user engagement and emotional connection.

The invention overcomes these limitations by combining durable construction with an innovative mechanism for displaying photographs within a foldable structure. A photograph display area is incorporated into the second section of the book, with an opening on its surface allowing a photograph to be revealed when the book is fully opened. The first and third sections are foldably connected to the second section, enabling them to conceal the photograph display area when folded inward. This configuration introduces an element of discovery, enhancing the interactive experience for the user. Whether used as a tool for storytelling, memory sharing, or early childhood engagement, the invention allows for personal photographs to be seamlessly integrated into the book's structure.

Unlike prior art, which often relies on fragile adhesive-backed pockets or printed photographs, this invention supports multiple methods of photograph integration. These include physical pockets for inserting prints, direct printing of photographs onto the surface of the book, or other affixing mechanisms, ensuring versatility and adaptability to a range of user preferences and manufacturing processes. Additionally, the invention's modular design allows for different material constructions, thematic integrations, and optional features such as electronic components or integration with photo printing services, further addressing the limitations of existing solutions.

The invention's durable design makes it suitable for use by young children, while its ability to incorporate personal photographs fosters emotional connection and engagement. The interactive conceal-and-reveal mechanism not only enhances the user's experience but also introduces a playful storytelling element absent from prior solutions.

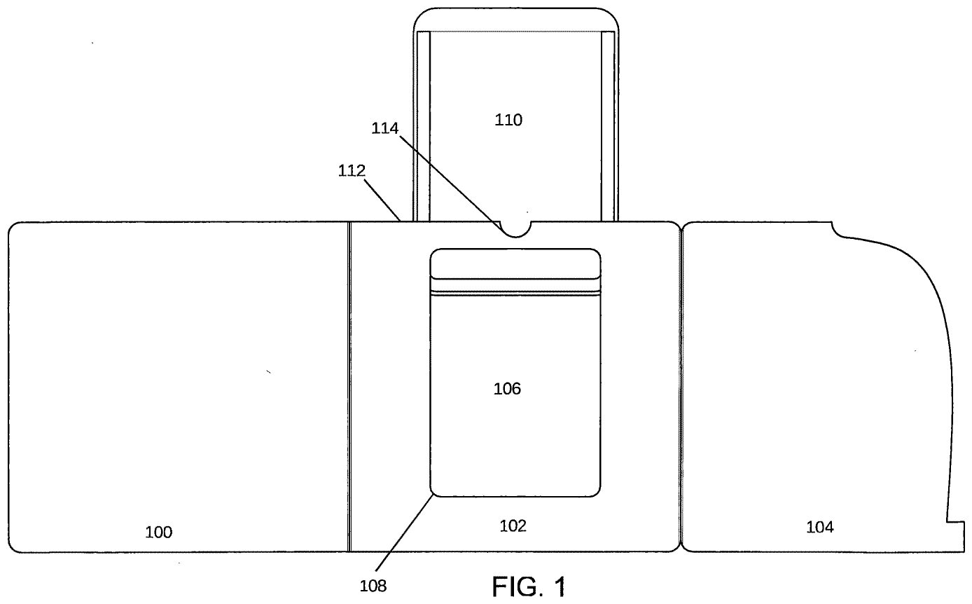

Referring now to the drawings, FIG. 1 illustrates a book in an open configuration, comprising a first section 100, a second section 102, and a third section 104. The first section 100 and third section 104 are foldably connected to opposing edges of the second section 102, allowing them to rotate relative to the second section 102. The surfaces of these sections form the pages of the book when unfolded. The second section 102 includes a photograph display area 106, which is visible through an opening 108 formed in its inner surface. The photograph display area 106 is shown configured to receive a photograph holder 110 that can be inserted into or removed from a photo-receiving pocket 112 integrated into the second section 102.

The photo-receiving pocket 112 comprises an indent 114 for allowing the photograph holder 110 to be easily gripped and removed when fully inserted.

The photograph holder 110 is depicted partially withdrawn from the photo-receiving pocket 112. The opening 108 aligns with the photograph holder 110 when it is fully inserted, allowing a photograph secured within the holder to be visible through the opening 108. The opening 108 may in some examples be covered by a transparent sheet. The opening 108 may have a rectangular configuration as shown, but alternative shapes, such as circular or decorative patterns, may be implemented depending on design or thematic requirements. The photo-receiving pocket 112 may be formed by laminating a transparent sheet over the inner surface of the second section 102 or by constructing a flexible sleeve using fabric or polymeric materials.

The first section 100 and third section 104 are foldable over the second section 102, enabling the photograph and the opening 108 to be concealed when the third section 104 is folded inward. The sections 100, 102, and 104 may be constructed from various materials, including rigid board material, fabric, or laminated composites, depending on the intended durability and user application. In some implementations, the first section 100 and third section 104 may include decorative features or story-relevant designs that align with the photograph display area 106 when folded.

While the figure depicts a photo-receiving pocket 112 as the method of integrating photographs, alternative implementations may include photographs printed directly onto the surface of the second section 102 or adhered to the surface using adhesives or other attachment methods. Additionally, the book structure may incorporate multiple photo-receiving pockets or openings to accommodate multiple photographs across different pages. Optional features such as alignment tabs for the photograph holder 110 or transparent overlays for the opening 108 may also be included to enhance usability and protection of the photographs.

The foldable connections between the sections 100, 102, and 104 may be implemented using scored fold lines in rigid materials or stitched hinges in fabric constructions. In some examples, magnets, hook-and-loop fasteners, or similar securing mechanisms may be employed to hold the sections in a folded configuration.

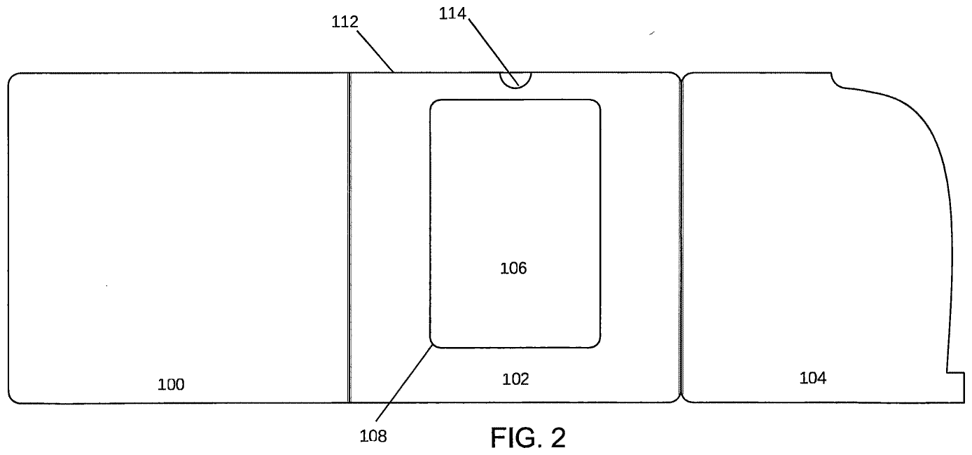

FIG. 2 illustrates the book in an open configuration similar to that of FIG. 1, with the photograph holder fully inserted into the photo-receiving pocket of the second section 102. In this configuration, the photograph secured within the holder would be fully visible through the opening 108 formed in the inner surface of the second section 102. The first section 100 and third section 104 remain unfolded, leaving the photograph and the photograph display area 106 exposed.

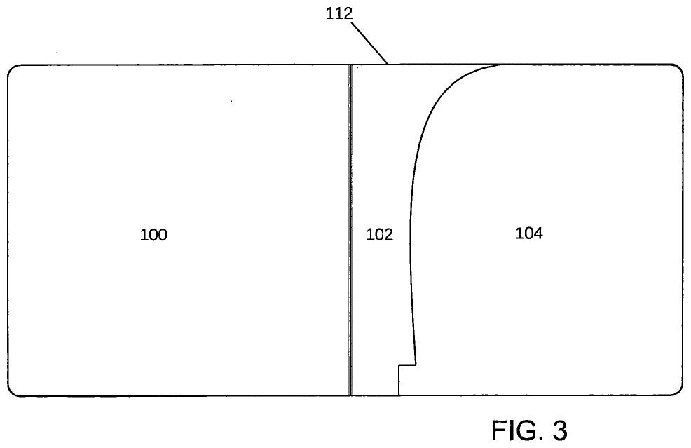

FIG. 3 shows the book in a partially closed configuration, where the third section 104 has been folded inward over the second section 102. In this state, the photograph display area 106 and the opening 108 are fully concealed by the opaque third section 104, while the first section 100 remains unfolded. This configuration demonstrates the book as it appears when initially opened by a user, with the photograph display area hidden until the third section 104 is unfolded. This figure emphasizes the conceal-and-reveal functionality of the folding structure, adding an interactive element to the book that increases children's engagement.

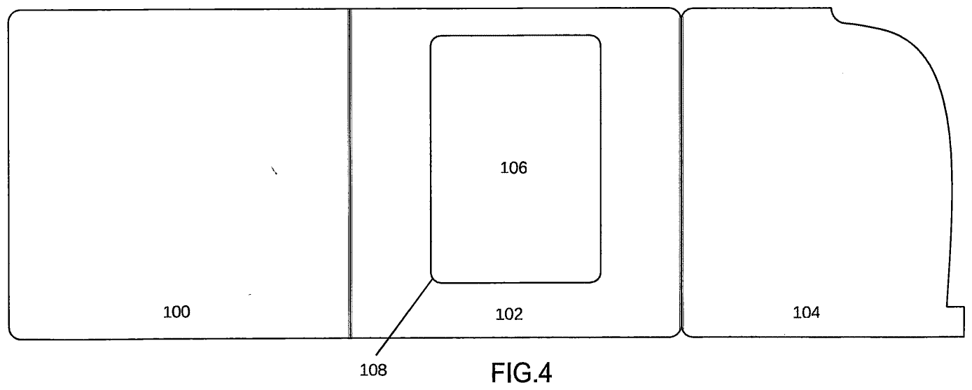

FIG. 4 illustrates a different variation of the book in an open configuration, where the photograph 116 is permanently printed onto the inner surface of the second section 102, rather than being placed within a photo-receiving pocket. The first section 100 and third section 104 remain unfolded, similar to FIG. 2. This figure demonstrates an alternative implementation of the photograph display area 106, where the photograph is integrated into the book structure during manufacturing or as a post-process when the book is purchased. This configuration eliminates the need for removable components, offering a simplified yet functional design while maintaining the same interactive and visual features.

### CONCLUSION

Unless otherwise defined, all terms (including technical terms) used herein have the same meaning as commonly understood by one having ordinary skill in the art to which this invention belongs. It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

The disclosed embodiments are illustrative, not restrictive. While specific configurations of the children's book toy of the invention have been described in a specific manner referring to the illustrated embodiments, it is understood that the present invention can be applied to a wide variety of solutions which fit within the scope and spirit of the claims. There are many alternative ways of implementing the invention.

It is to be understood that the embodiments of the invention herein described are merely illustrative of the application of the principles of the invention. Reference herein to details of the illustrated embodiments is not intended to limit the scope of the claims, which themselves recite those features regarded as essential to the invention.

What is claimed is:

1. A book comprising:
a first section, a second section, and a third section, wherein the first section and the third section are foldably connected to opposing edges of the second section, the surfaces of the first, second, and third sections forming respective pages of the book;
a photograph display area associated with the second section, the photograph display area being configured to present a photograph;
wherein the first and third sections are foldable relative to the second section, such that when the third section is folded inward over the second section, the opening and the photograph visible through it are concealed.

2. The book of claim 1, wherein the photograph display area comprises a photo-receiving pocket integrated into the second section, the pocket configured to receive and retain a photograph or a photograph holder.

3. The book of claim 2, wherein the photo-receiving pocket includes a top access opening to facilitate insertion and removal of the photograph or the photograph holder.

4. The book of claim 2, wherein the photo-receiving pocket is configured to receive photographs of multiple standard sizes.

5. The book of claim 2, wherein the photo-receiving pocket includes alignment tabs or guides to assist in positioning the photograph or the photograph holder.

6. The book of claim 2, wherein the photo-receiving pocket is formed by laminating or bonding a transparent sheet to the inner surface of the second section.

7. The book of claim 1, wherein the photograph display area comprises a photograph permanently printed onto the inner surface of the second section.

8. The book of claim 1, wherein the photograph display area comprises a photograph affixed to the inner surface of the second section using an adhesive, fastener, or other securing means.

9. The book of claim 1, wherein the first, second, and third sections are constructed from board material.

10. The book of claim 1, wherein the first, second, and third sections are constructed from fabric material.

11. The book of claim 1, wherein the first and third sections include flaps integrated into their respective surfaces, the flaps being configured with shapes and designs corresponding to different story themes.

12. The book of claim 1, wherein the book includes multiple photo-receiving pockets integrated into the second section, each configured to display a separate photograph.

13. The book of claim 1, wherein the first and third sections include decorative cutouts or transparent windows configured to partially reveal portions of the photograph when the book is folded.

14. The book of claim 1, wherein the photograph display area is configured to integrate with a digital or electronic component to display photographs electronically.

15. The book of claim 14, wherein the electronic component includes a touchscreen or sensor to allow interactive engagement with the photograph.

16. The book of claim 1, wherein the book is configured to integrate with a photo printing service, allowing users to order customized photographs pre-fitted to the dimensions of the photograph display area.

17. The book of claim 1, wherein an opening is formed in the inner surface of the second section, the opening positioned to reveal the photograph in the photograph display area.

18. The book of claim 1, wherein the first and third sections are secured in their folded position using magnets, hook-and-loop fasteners, or other releasable securing elements.

19. The book of claim 1, wherein the photograph display area includes a customizable overlay to enhance or modify the appearance of the photograph.

20. The book of claim 1, wherein the book includes additional sections, each with a photograph display area, enabling multiple concealed and revealed photographs across different pages of the book.
